(19) United States
(12) Patent Application Publication
(10) Pub. No.: US 2025/0231559 A1
(43) Pub. Date: Jul. 17, 2025

(54) METHOD AND PROCESS TO MATCH PREDICTIVE ALERTS TO INTERVENING MAINTENANCE ACTIONS

(71) Applicant: THE BOEING COMPANY, Arlington, VA (US)

(72) Inventors: Liessman E. STURLAUGSON, St. Louis, MO (US); Vinay Raj Manjunath HAMPAPUR, Danville, CA (US); Jeremy K. ASOMANING, Seattle, WA (US)

(21) Appl. No.: 18/410,933

(22) Filed: Jan. 11, 2024

(51) Int. Cl. G05B 23/02

(52) U.S. Cl. CPC G05B 23/0283; G05B 23/027; G05B 23/0275

(57) ABSTRACT

The present disclosure provides a method including extracting structured maintenance action information from an authoritative maintenance source. The authoritative maintenance source defines a plurality of faults for a system and a respective set of one or more maintenance actions for each of the plurality of faults. The method further includes generating, for at least one fault, a respective first map of the fault to one or more relevant portions of the structured maintenance action information. The method further includes generating, for a received predictive alert, a second map of one or more related faults. The method further includes identifying, based on the first maps, the second map, and maintenance records analyzed according to the structure maintenance action information, a maintenance action that is most likely indicated by the predictive alert.

### FIELD

Aspects of the present disclosure relate to managing unscheduled maintenance, and more specifically, identifying maintenance actions for predictive alerts received in a system.

### BACKGROUND

Outside of employee compensation and fuel costs, the unscheduled maintenance of aircraft presents one of the greatest operating costs within the airline industry. Thus, the ability to measure and optimize the effectiveness of unscheduled maintenance is important to maintain cost-effective operations. The ability to identify the most effective maintenance actions depends on identifying which maintenance action responds to which fault.

In one conventional approach, fault occurrences can be matched to maintenance actions where the set of faults and the set(s) of fault isolation steps and maintenance actions are predefined and have been fully enumerated. However, this approach is relatively limited, and does not consider predictive alerts, which indicate that a fault has not yet occurred but is likely to imminently occur. Further, the set of predictive alerts tends to be updated with some regularity (e.g., during the service life of an aircraft model) as new predictive alerts are developed to warn of possible fault conditions.

### SUMMARY

The present disclosure provides a method in one aspect, the method including: extracting structured maintenance action information from an authoritative maintenance source, the authoritative maintenance source defining a plurality of faults for a system and a respective set of one or more maintenance actions for each of the plurality of faults. The method further includes generating, for at least one fault of the plurality of faults, a respective first map of the fault to one or more relevant portions of the structured maintenance action information. The method further includes generating, for a received predictive alert, a second map of one or more related faults identified from the plurality of faults. The method further includes identifying, based on the first maps, the second map, and maintenance records analyzed according to the structured maintenance action information, a maintenance action that is most likely indicated by the predictive alert.

In one aspect, in combination with any example method above or below, the system comprises an aircraft, and the authoritative maintenance source comprises a fault isolation manual (FIM).

In one aspect, in combination with any example method above or below, generating the respective first map of the fault to the one or more relevant portions comprises performing natural language processing on the structured maintenance action information to identify a set of keywords and a relative frequency of each keyword in the set.

In one aspect, in combination with any example method above or below, generating the respective first map of the fault to the one or more relevant portions further comprises identifying, from the set of keywords, a subset of one or more keywords having a highest relative frequency.

In one aspect, in combination with any example method above or below, identifying one or more related faults for the predictive alert comprises one of the following: determining that the predictive alert directly predicts a fault, determining that the predictive alert predicts a common cause of the fault, and determining that the predictive alert predicts a common effect of the fault.

In one aspect, in combination with any example method above or below, analyzing the maintenance records comprises identifying one or more of the following within individual maintenance records: one or more references to the authoritative maintenance source; one or more part numbers; one or more serial numbers; and one or more installation indicators or removal indicators.

In one aspect, in combination with any example method above or below, the method further includes comparing a likelihood of the identified maintenance action with a threshold value, and inferring, when the likelihood does not exceed the threshold value, that the predictive alert did not result in a maintenance action.

The present disclosure provides a computer program product in one aspect, the computer program product including: a computer-readable storage medium having computer-readable program code embodied therewith, the computer-readable program code executable by one or more computer processors to perform an operation. The operation includes extracting structured maintenance action information from an authoritative maintenance source, the authoritative maintenance source defining a plurality of faults for a system and a respective set of one or more maintenance actions for each of the plurality of faults. The operation further includes generating, for at least one fault of the plurality of faults, a respective first map of the fault to one or more relevant portions of the structured maintenance action information. The operation further includes generating, for a received predictive alert, a second map of one or more related faults identified from the plurality of faults. The operation further includes identifying, based on the first maps, the second map, and maintenance records analyzed according to the structured maintenance action information, a maintenance action that is most likely indicated by the predictive alert.

In one aspect, in combination with any example computer program product above or below, the system comprises an aircraft, and the authoritative maintenance source comprises a fault isolation manual (FIM).

In one aspect, in combination with any example computer program product above or below, generating the respective first map of the fault to the one or more relevant portions comprises performing natural language processing on the structured maintenance action information to identify a set of keywords and a relative frequency of each keyword in the set.

In one aspect, in combination with any example computer program product above or below, generating the respective first map of the fault to the one or more relevant portions further comprises identifying, from the set of keywords, a subset of one or more keywords having a highest relative frequency.

In one aspect, in combination with any example computer program product above or below, identifying one or more related faults for the predictive alert comprises one of the following: determining that the predictive alert directly predicts a fault; determining that the predictive alert predicts a common cause of the fault; and determining that the predictive alert predicts a common effect of the fault.

In one aspect, in combination with any example computer program product above or below, analyzing the maintenance records comprises identifying one or more of the following within individual maintenance records: one or more references to the authoritative maintenance source; one or more part numbers; one or more serial numbers; and one or more installation indicators or removal indicators.

In one aspect, in combination with any example computer program product above or below, the operation further includes comparing a likelihood of the identified maintenance action with a threshold value, and inferring, when the likelihood does not exceed the threshold value, that the predictive alert did not result in a maintenance action.

The present disclosure provides a system of identifying maintenance action for received predictive alerts in one aspect, the system including a memory storing an authoritative maintenance source and maintenance records, and one or more processors configured to extract structured maintenance action information from the authoritative maintenance source, the authoritative maintenance source defining a plurality of faults and a respective set of one or more maintenance actions for each of the plurality of faults. The one or more processors are further configured to generate, for at least one fault of the plurality of faults, a respective first map of the fault to one or more relevant portions of the structured maintenance action information. The one or more processors are further configured to generate, for a received predictive alert, a second map of one or more related faults identified from the plurality of faults. The one or more processors are further configured to identify, based on the first maps, the second map, and maintenance records analyzed according to the structured maintenance action information, a maintenance action that is most likely indicated by the predictive alert.

In one aspect, in combination with any example system above or below, the authoritative maintenance source comprises a fault isolation manual (FIM) for an aircraft.

In one aspect, in combination with any example system above or below, generating the respective first map of the fault to the one or more relevant portions comprises performing natural language processing on the structured maintenance action information to identify a set of keywords and a relative frequency of each keyword in the set.

In one aspect, in combination with any example system above or below, identifying one or more related faults for the predictive alert comprises one of the following: determining that the predictive alert directly predicts a fault, determining that the predictive alert predicts a common cause of the fault, and determining that the predictive alert predicts a common effect of the fault.

In one aspect, in combination with any example system above or below, analyzing the maintenance records comprises identifying one or more of the following within individual maintenance records: one or more references to the authoritative maintenance source, one or more part numbers, one or more serial numbers, and one or more installation indicators or removal indicators.

In one aspect, in combination with any example system above or below, the one or more processors are further configured to compare a likelihood of the identified maintenance action with a threshold value, and infer, when the likelihood does not exceed the threshold value, that the predictive alert did not result in a maintenance action.

### BRIEF DESCRIPTION OF THE DRAWINGS

So that the manner in which the above recited features can be understood in detail, a more particular description, briefly summarized above, may be had by reference to example aspects, some of which are illustrated in the appended drawings.

FIG. 1 depicts an exemplary maintenance system, according to one or more aspects.

FIG. 2 depicts an exemplary method of identifying maintenance actions for predictive alerts received in a system, according to one or more aspects.

FIG. 3 depicts an exemplary technique of generating maps of predictive alerts to structured maintenance action information, according to one or more aspects.

FIG. 4 depicts an exemplary technique of analyzing maintenance records for the system according to the structured maintenance action information, according to one or more aspects.

FIG. 5 depicts an exemplary technique of disambiguating maintenance actions to faults, according to one or more aspects.

FIG. 6 depicts an exemplary technique of matching predictive alerts to maintenance actions, according to one or more aspects.

### DETAILED DESCRIPTION

According to various aspects described herein, a maintenance service can match each occurrence of a predictive alert of an aircraft to an intervening maintenance action when the maintenance action is taken. When no maintenance action is taken responsive to the predictive alert, the maintenance service can infer that the predictive alert was ignored. As used herein, “ignored” indicates that the predictive alert did not result in an intervening maintenance action. The maintenance service extracts structured maintenance information that is predefined in one or more authoritative maintenance sources (e.g., technical manuals) from maintenance records. The maintenance service generates maps between the predictive alerts, a plurality of faults in the structured maintenance information, and/or other structured maintenance information. The maintenance service further determines a confidence for matching each occurrence of a predictive alert to candidate maintenance actions.

In the current disclosure, reference is made to various aspects. However, it should be understood that the present disclosure is not limited to specific described aspects. Instead, any combination of the following features and elements, whether related to different aspects or not, is contemplated to implement and practice the teachings provided herein. Additionally, when elements of the aspects are described in the form of “at least one of A and B,” it will be understood that aspects including element A exclusively, including element B exclusively, and including element A and B are each contemplated. Furthermore, although some aspects may achieve advantages over other possible solutions and/or over the prior art, whether or not a particular advantage is achieved by a given aspect is not limiting of the present disclosure. Thus, the aspects, features, aspects and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

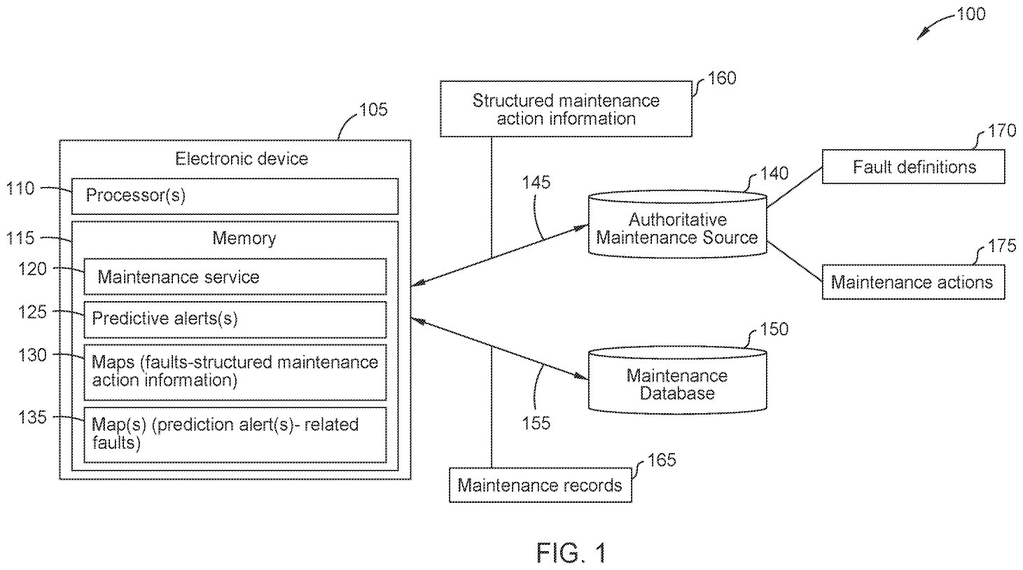

Refer now to FIG. 1, which depicts an exemplary maintenance system 100 (also referred to as “system 100”) according to one or more aspects. The maintenance system 100 may be used in conjunction with other aspects described herein. While described primarily in terms of maintenance management performed within the airline industry, the principles described herein are also applicable to maintenance management performed within other industries.

The maintenance system 100 comprises an electronic device 105, an authoritative maintenance source 140, and a maintenance database 150. As used herein, an “electronic device” generally refers to any device having electronic circuitry that provides a processing or computing capability, and that implements logic and/or executes program code to perform various operations that collectively define the functionality of the electronic device. The functionality of the electronic device includes a communicative capability with one or more other electronic devices, e.g., when connected to a same network. An electronic device may be implemented with any suitable form factor, whether relatively static in nature (e.g., mainframe, computer terminal, server, kiosk, workstation) or mobile (e.g., laptop computer, tablet, handheld, smart phone, wearable device). The communicative capability between electronic devices may be achieved using any suitable techniques, such as conductive cabling, wireless transmission, optical transmission, and so forth.

In some aspects, the electronic device 105 is implemented separate from the system(s) that are being monitored for maintenance purposes. For example, the electronic device 105 may be implemented as a computing device that is external to (or remote from) an aircraft. In other aspects, the electronic device 105 may be integrated partly or fully in the system(s) that are being monitored.

The electronic device 105 comprises one or more processors 110 and a memory 115. The one or more processors 110 are any electronic circuitry, including, but not limited to one or a combination of microprocessors, microcontrollers, application-specific integrated circuits (ASIC), application-specific instruction set processors (ASIP), and/or state machines, that is communicatively coupled to the memory 115 and controls the operation of the electronic device 105. The one or more processors 110 are not limited to a single processing device and may encompass multiple processing devices.

The one or more processors 110 may include other hardware that operates software to control and process information. In some aspects, the one or more processors 110 execute software stored in the memory 115 to perform any of the functions described herein. The one or more processors 110 control the operation and administration of the electronic device 105 by processing information (e.g., information received from input devices and/or communicatively coupled electronic devices).

The memory 115 may store, either permanently or temporarily, data, operational software, or other information for the one or more processors 110. The memory 115 may include any one or a combination of volatile or non-volatile local or remote devices suitable for storing information. For example, the memory 115 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 115, a disk, a CD, or a flash drive. In particular embodiments, the software may include an application executable by the one or more processors 110 to perform one or more of the functions described herein.

In this example, the memory 115 stores a maintenance service 120 that communicates with the authoritative maintenance source 140 and the maintenance database 150. The authoritative maintenance source 140 stores a plurality of fault definitions 170 and a plurality of maintenance actions 175, each of which may be accessed by the maintenance service 120. In this way, the authoritative maintenance source 140 defines a set of possible faults for the system 100 using the plurality of fault definitions 170, and defines a respective set of one or more maintenance actions 175 (e.g., that are prescribed) for each of the plurality of faults. The plurality of fault definitions 170 and the plurality of maintenance actions 175 include structured maintenance action information 160 that may have any suitable formatting. For example, each fault definition 170 may be represented in the authoritative maintenance source 140 as a fault record comprising a set of one or more values corresponding to a set of one or more fields. In some aspects, each fault record comprises values for: an aircraft model, an Air Transport Association (ATA) system code, a maintenance message name and/or code, one or more symptoms of the fault definition 170, other identifiers, and so forth. Other implementations of fault records are also contemplated. The values of each fault record generally include alphanumeric values, and one or more of the values may include free-form (e.g., unstructured) text.

The information stored by the authoritative maintenance source 140 may be organized or delineated in any suitable manner. In some aspects, the authoritative maintenance source 140 comprises a fault isolation manual (FIM; defining the plurality of faults), one or more aircraft maintenance manuals (AMMs), a set of a plurality of corrective actions (defining the plurality of maintenance actions 175), and a set of keywords. Other implementations of the authoritative maintenance source 140 are also contemplated (e.g., including one or more technical manuals). In some aspects, various fault records within the fault isolation manual include references to different portions of the authoritative maintenance source 140 (the AMM(s), the maintenance actions 175, and/or the set of keywords).

In some aspects, the authoritative maintenance source 140 is implemented in a database (e.g., a database server device). In other aspects, the authoritative maintenance source 140 is implemented in another type of electronic device. In yet other aspects, the authoritative maintenance source 140 is stored in the memory 115 of the electronic device 105.

The maintenance database 150 comprises a plurality of maintenance records 165, where each maintenance record 165 comprises a set of one or more values corresponding to a set of one or more fields. In some aspects, each maintenance record 165 comprises values for one or more part numbers, one or more serial numbers, one or more installation indicators or removal indicators, and so forth. The values of each maintenance record 165 generally include alphanumeric values, and one or more of the values may include free-form (e.g., unstructured) text. Each maintenance record 165 may further comprise one or more references to the authoritative maintenance source 140.

As shown in the system 100, the maintenance database 150 is implemented in a database. In other aspects, the maintenance database 150 is implemented in another type of electronic device. In yet other aspects, the maintenance database 150 is stored in the memory 115 of the electronic device 105.

The electronic device 105 is communicatively coupled with the authoritative maintenance source 140 by a first communicative link 145, and with the maintenance database 150 by a second communicative link 155. In some aspects, the communicative links 145, 155 are formed in one or more local area networks (LANs) and/or a wide area network (WAN). Generally, a WAN (e.g., the internet) is capable of communicating computer data over non-local distances by any technology for communicating computer data, now known or to be developed in the future. In some aspects, the WAN may be replaced and/or supplemented by one or more LANs designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

The maintenance service 120 further accesses one or more predictive alerts 125, where each predictive alert 125 indicates that one of the faults that are defined by the fault definitions 170 has not yet occurred, but is likely to occur within a predetermined time period. In some aspects, each predictive alert 125 comprises a set of one or more values corresponding to a set of one or more fields. In some aspects, each predictive alert 125 comprises values for an aircraft model, an ATA system code, an alert code, an alert text, an alert description, a chart title, an x-axis title, a y-axis title, a parameter name, a trigger name, an alert action, an alert confidence, and so forth. Other implementations of the predictive alerts 125 are also contemplated. The values of each predictive alert 125 generally include alphanumeric values, and one or more of the values may include free-form (e.g., unstructured) text.

As shown, the one or more predictive alerts 125 are stored in the memory 115. In other aspects, the predictive alerts 125 may be stored in a database separate from the memory 115, or may be included in another electronic device. In one example, the predictive alerts 125 may be stored in the authoritative maintenance source 140.

In some aspects, the information stored in the authoritative maintenance source 140 is relatively static when compared to the one or more predictive alerts 125. Stated another way, the one or more predictive alerts 125 may be updated with a greater frequency than the authoritative maintenance source 140. In some aspects, new predictive alerts 125 continue to be developed after an aircraft model has entered into service. In some cases, the newly-developed predictive alerts 125 are linked to the authoritative maintenance source 140 (e.g., including one or more references to an AMM and/or a FIM of the authoritative maintenance source 140).

As mentioned above, the ability to measure and optimize the effectiveness of unscheduled maintenance is important to maintain cost-effective operations. This depends on identifying which maintenance action(s) responds to which fault(s). While fault occurrences can be matched to maintenance actions in one conventional approach, this solution is restricted to matching faults only, in which the set of faults for each aircraft model are previously defined and enumerated and the set of fault isolation steps and maintenance actions are known.

In some cases, the aircraft operators may attempt to directly track the reason(s) preceding each maintenance action. For example, an airline may record the fault occurrence(s) and/or alert instance(s) as being associated with a particular work order. However, many aircraft operators do not perform this direct tracking, or decline to share their tracking data with the aircraft manufacturer. Further, different operators who perform direct tracking may do so differently, e.g., due to differences in personnel, the overall objectives for monitoring, monitoring alerts and faults, scheduling maintenance, performing maintenance, and signing off on maintenance. As a result, the tracking data received by the aircraft manufacturer from different operators may not be uniform.

In some aspects, the maintenance service 120 extracts structured maintenance information that is predefined in the authoritative maintenance source 140, and/or information included in the maintenance records 165. In some aspects, the extracted structured maintenance information includes some or all of the following: descriptions of possible causes of a fault, one or more references to portions of the authoritative maintenance source (e.g., AMMs, FIMs), equipment numbers, part numbers, keywords, and so forth.

Generally, the maintenance service 120 generates maps between the predictive alerts 125, a plurality of fault definitions 170 in the structured maintenance information 160, and/or other structured maintenance information 160. In some aspects, the maintenance service 120 generates, for each fault of the plurality of fault definitions 170, a respective first map 130 of the fault to one or more relevant portions of the structured maintenance action information 160. In some aspects, the maintenance service 120 generates, for a predictive alert 125, a second map 135 of one or more related faults identified from the plurality of fault definitions 170.

In some aspects, the maintenance service 120 further determines a confidence for matching each occurrence of a predictive alert 125 to candidate maintenance actions 175. In some aspects, the maintenance service 120 matches each occurrence of a predictive alert 125 of an aircraft to an intervening maintenance action 175 when the maintenance action 175 is taken. When no maintenance action is taken responsive to the predictive alert, the maintenance service 120 can infer that the predictive alert 125 was ignored (i.e., the predictive alert 125 did not result in an intervening maintenance action 175).

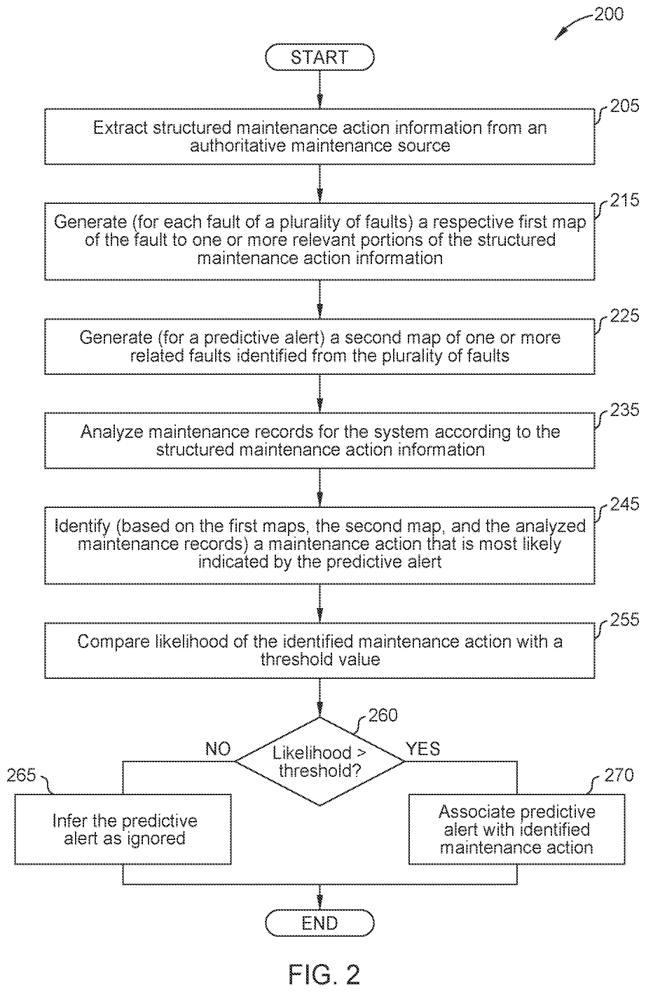

FIG. 2 depicts an exemplary method 200 of identifying maintenance actions for predictive alerts received in a system, according to one or more aspects. The method 200 may be performed in conjunction with other aspects described herein. For example, the method 200 may be performed by the maintenance service 120 of FIG. 1.

The method 200 begins at block 205, where the maintenance service 120 extracts structured maintenance action information from an authoritative maintenance source. In some aspects, the system comprises an aircraft, and the authoritative maintenance source comprises a FIM. In some aspects, the authoritative maintenance source defines a plurality of faults for the system, and a respective set of one or more (corrective) maintenance actions for each of the plurality of faults. Each of the faults and/or the maintenance actions may include one or more values corresponding to one or more predefined fields. The values of each fault and/or maintenance action generally include alphanumeric values, and may include free-form (e.g., unstructured) text. In some aspects, the extracted structured maintenance information includes any, some, or all of the following: descriptions of possible causes of a fault, one or more references to portions of the authoritative maintenance source (e.g., AMMs, FIMs), equipment numbers, part numbers, keywords, and so forth.

Any suitable techniques may be used to extract the structured maintenance action information from the authoritative maintenance source. In some aspects, one or more natural language processing (NLP) techniques are applied to the information within the authoritative maintenance source to extract the structured maintenance action information. For example, the maintenance service 120 may perform named-entity recognition (NER) on unstructured text within various fields of the FIM to determine part names, may perform tokenization and/or normalization of the unstructured text to process errors, shorthand, or abbreviations present in the unstructured text, and so forth.

At block 215, the maintenance service 120 generates, for each fault of the plurality of faults, a respective first map of the fault to one or more relevant portions of the structured maintenance action information. In some aspects, generating the respective first map of the fault to the one or more relevant portions comprises performing one or more NLP techniques on the structured maintenance action information to identify a set of keywords and a relative frequency of each keyword in the set. One example of the one or more NLP techniques is Term Frequency-Inverse Document Frequency (TF-IDF), although other techniques are also contemplated. In some aspects, generating the respective first map comprises identifying, from the set of keywords, a subset of one or more keywords having a highest relative frequency.

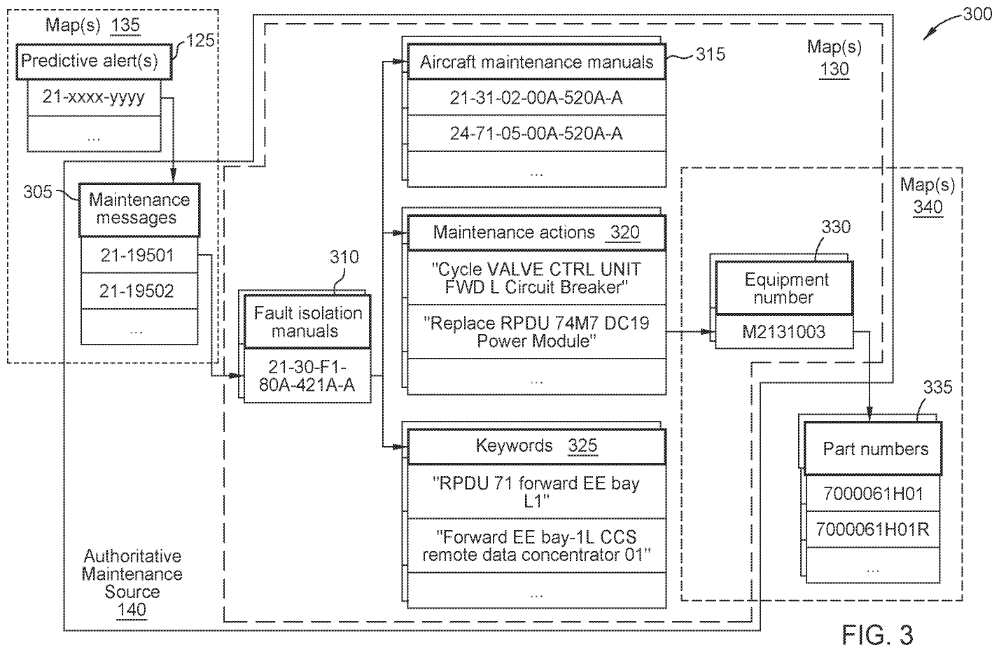

Refer also to FIG. 3, which depicts an exemplary technique of generating maps of predictive alerts to structured maintenance action information, according to one or more aspects. More specifically, the diagram 300 illustrates various components of the authoritative maintenance source 140, one or more maps 130 between faults and structured maintenance action information, one or more maps 135 between predictive alert(s) and the one or more related faults, and one or more maps 340 between fault occurrences and maintenance actions.

The authoritative maintenance source 140 includes a plurality of maintenance messages 305, one or more fault isolation manuals 310, a plurality of AMMs 315, a plurality of maintenance actions 320, a plurality of keywords 325, and a plurality of equipment numbers 330. In some aspects, each maintenance message of the plurality of maintenance messages 305 corresponds to a fault in a 1:1 ratio (that is, each maintenance message indicates a single fault). Each of the maintenance messages 305 references one of the fault isolation manuals 310, which in turn references one or more of the AMMs 315, one or more of the maintenance actions 320, and one or more of the keywords 325. Each of the maintenance actions 320 references one or more of the equipment numbers 330.

As shown, the one or more maps 340 map between the plurality of equipment numbers 330 and a plurality of part numbers 335. In some aspects, the one or more maps 340 may be predefined or determined by a component other than the maintenance service 120. The one or more maps 130 are generated by the maintenance service 120 to map between one or more faults (defined in the FIMs 310) various structured maintenance action information that is referenced by the FIMs 310. The one or more maps 135 are generated by the maintenance service 120 at block 225 (below) to map between one or more of the predictive alerts 125 and the maintenance messages 305. In some aspects, within the one or more maps 135, each predictive alert 125 typically maps to multiple ones of the maintenance messages 305, and any particular one of the maintenance messages 305 can be mapped to multiple ones of the predictive alerts 125.

In some aspects, generating the respective first map (i.e., of the maps 130) comprises parsing the AMMs 315 and the maintenance actions 320 (and related equipment numbers 330) that are referenced by the FIM 310. In some aspects, generating the respective first map further comprises extracting the keywords 325 from the FIM 310. In this way, the maintenance service 120 in some aspects automatically extracts keywords that are distinct to a set of related faults.

In some aspects, extracting the keywords 325 comprises performing one or more NLP techniques on the structured maintenance action information of the FIM 310 to identify a set of keywords and a relative frequency of each keyword in the set. One example of the one or more NLP techniques is TF-IDF, although other techniques are also contemplated. In some aspects, generating the respective first map comprises identifying, from the set of keywords, a subset of one or more keywords having a highest relative frequency.

At block 225, the maintenance service 120 generates, for a predictive alert, a second map (i.e., of the maps 135) of one or more related faults identified from the plurality of faults. In some aspects, identifying one or more related faults for the predictive alert comprises one of the following: determining that the predictive alert directly predicts a fault, determining that the predictive alert predicts a common cause of the fault, and determining that the predictive alert predicts a common effect of the fault. Although the block 225 is shown as following the block 215, in other aspects the blocks 215, 225 may be performed in the reverse order.

Generating the second map for the predictive alert may be achieved using any suitable techniques. In some aspects, the maintenance service 120 performs a ranking function that ranks the various faults according to respective confidence scores. In one example technique, the maintenance service 120: (1) filters the plurality of faults to those having a same aircraft model and/or ATA system code as the predictive alert, (2) extracts data from an alert action field and/or other text of the predictive alert, (3) constructs a bag-of-words (e.g., a set of keywords) using values of an x-axis title, a y-axis title, a parameter name, a trigger name, an alert text, an alert description, and/or an alert action, (4) determines a maximum similarity (e.g., representing a confidence value) of each keyword of the bag-of-words with values of a maintenance message name and/or a symptom of the particular fault of the filtered faults, (5) ranks the plurality of filtered faults according to the maximum similarity values, and (6) identifies one or more highest ranking faults that are mapped to the predictive alert. In one aspect, the one or more highest ranking faults are identified relative to a threshold value (e.g., at a knee or elbow point in a graph that corresponds to a large change for adjacent values). In some alternate aspects, generating the second map for the predictive alert may consider other extrinsic information when available (e.g., keywords from service letters associated with the predictive alert).

At block 235, the maintenance service 120 analyzes maintenance records for the system according to the structured maintenance action information. In some aspects, analyzing the maintenance records comprises detecting, extracting, and/or transforming information from the maintenance records according to the extracted structured maintenance action information (e.g., at the block 205). For example, the structured maintenance action information may include references to AMMs and/or FIMs, replaced or swapped part numbers, textual descriptions of underlying causes, and/or keywords from the FIM, and analyzing the maintenance records may reveal maintenance actions, references, part numbers, keywords, etc. in common with the structured maintenance action information (or otherwise associated with the structured maintenance action information).

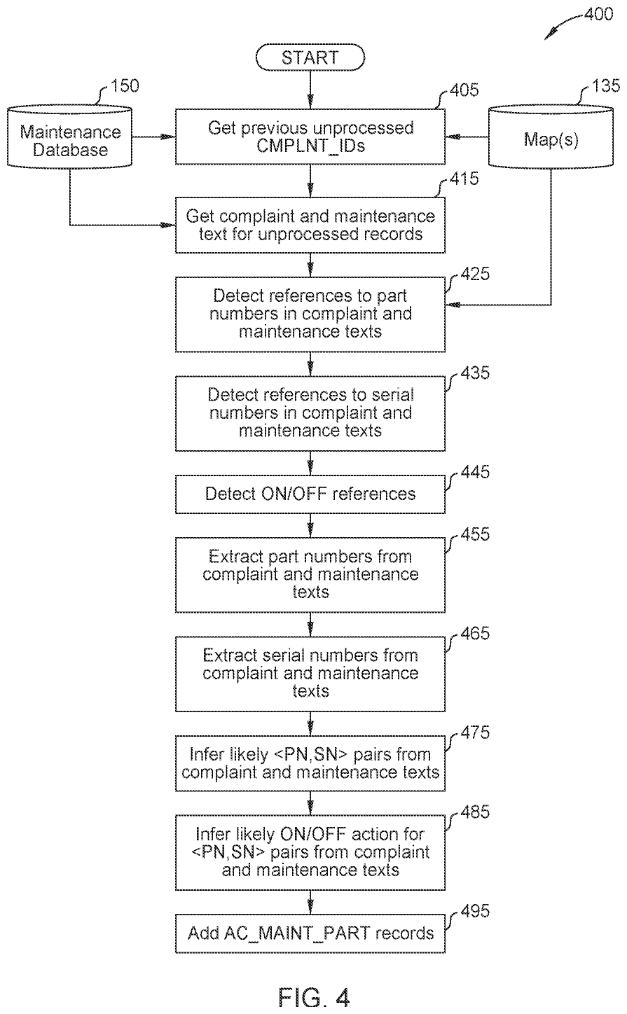

Analyzing the maintenance records may be achieved using any suitable techniques. The diagram 400 of FIG. 4 depicts an exemplary technique of analyzing maintenance records for the system according to the structured maintenance action information, according to one or more aspects. The technique begins at block 405, where the maintenance service 120 obtains unprocessed complaints from the maintenance database 150 and/or using the map(s) 135. At block 415, the maintenance service 120 obtains complaint and maintenance texts for one or more unprocessed maintenance records from the maintenance database 150.

In some aspects, analyzing the maintenance records comprises identifying one or more of the following within individual maintenance records: one or more references to the authoritative maintenance source, one or more part numbers, one or more serial numbers, and one or more installation indicators or removal indicators. In some aspects, the maintenance service 120 may perform named-entity recognition (NER), tokenization, and/or normalization of text to process errors, shorthand, or abbreviations present in maintenance records.

At block 425, the maintenance service 120 detects references to part numbers (e.g., “P/N”, “PN”, “PNO”) in the complaint and maintenance texts using the map(s) 135. At block 435, the maintenance service 120 detects references to serial numbers (e.g., “S/N”, “SN”, “SNO”) in the complaint and maintenance texts. At block 445, the maintenance service 120 detects references to one or more installation indicators (e.g., “ON”, “INST”) or removal indicators (e.g., “OFF”, “RMV”).

At block 455, the maintenance service 120 extracts part numbers from the complaint and maintenance texts (e.g., “PN ON [part number]”, “P/N [part number] OFF”). At block 465, the maintenance service 120 extracts serial numbers from the complaint and maintenance texts (e.g., “SN ON [serial number]”, “S/N [serial number] OFF”).

At block 475, the maintenance service 120 infers likely pairs of part numbers and serial numbers from the complaint and maintenance texts (e.g., “PN [part number] SN [serial number]”, “PN [part number] SN [serial number 1]/[serial number 2]”). At block 485, the maintenance service 120 infers likely installation or removal action(s) for the pairs from the complaint and maintenance texts (e.g., “PN ON [part number] SN ON [serial number]”, “PN [part number] SN OFF/ON [serial number 1]/[serial number 2]”). At block 495, the maintenance service 120 updates the maintenance records of the maintenance database 150, adding the inferred installation or removal action(s) as structured fields within the maintenance records.

Returning to FIG. 2, at block 245, the maintenance service 120 identifies, based on the first maps, the second map, and the analyzed maintenance records, a maintenance action that is most likely indicated by the predictive alert. Identifying the maintenance action that is most likely indicated by the predictive alert may be achieved using any suitable techniques. In some aspects, each predictive alert is scored against each maintenance action based on the map(s) 135 and the presence and quality of the structured maintenance action information corresponding to each fault.

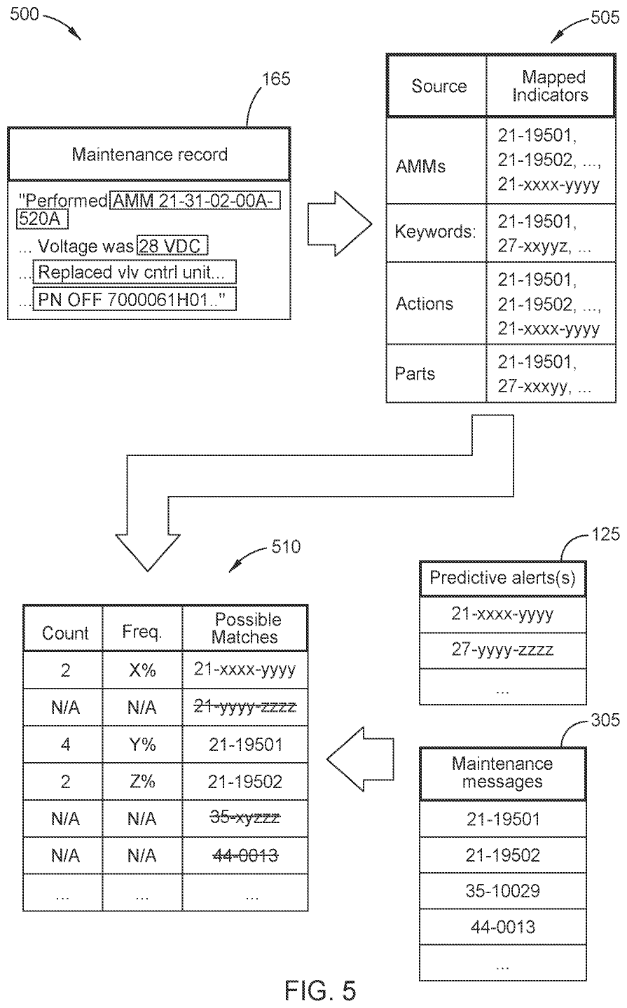

The diagram 500 of FIG. 5 depicts an exemplary technique of disambiguating maintenance actions to faults, according to one or more aspects. The table 505 generally represents information that is stored in the authoritative maintenance source 140 and that may be reflected in the map(s) 130.

Each of the predictive alerts 125 and the maintenance messages 305 are identified in a table 510 as possible matches (or candidate matches) for a maintenance action of the maintenance record 165. The results of analyzing the maintenance record 165 (e.g., identifying various indicators within the maintenance action) are mapped using the table 505 (e.g., the map(s) 130), to determine frequency information that is also included in the table 510. As shown, the table 510 includes a count of instances and a frequency of instances of the possible matches. Other implementations may include only one of the count or the frequency of instances.

In the diagram 500, table 505 includes two (2) instances of a first possible match (that is, predictive alert “21-xxxx-yyyy”), four (4) instances of a second possible match (maintenance message “21-19501”), and two (2) instances of a third possible match (maintenance message “21-19502”). In some aspects, a relative frequency for each of the possible matches may also be calculated. Thus, in the example shown in the diagram 500, the maintenance action of the maintenance record 165 is most likely indicated by the predictive alert “21-xxxx-yyyy”. Notably, as the table 505 indicates that the maintenance messages “21-19501” and “21-19502” also occurred, it is possible that the maintenance service 120 may be responding to those maintenance messages. It is more likely, however, that the predictive alert “21-xxxx-yyyy” was predicting the occurrence of the faults associated with the maintenance messages.

In some alternate aspects, matching each of the predictive alerts 125 with a most likely maintenance action comprises weighting the candidate matches (i.e., a pairing of a predictive alert 125 with a maintenance action), which may be performed in a number of ways. In one example, the weight of a candidate match may be adjusted lower or higher based on a lesser or greater frequency historical occurrence of the predictive alert, fault, and/or maintenance action. In another example, the weight of a candidate match may be adjusted lower or higher based on a lesser or greater accuracy of the process used to extract the structured maintenance action information extraction process (e.g., part numbers included in structured maintenance action information are detected with a lesser accuracy than AMM references). Other techniques for determining or adjusting a relative confidence of the candidate matches are also contemplated.

At block 255, the maintenance service 120 compares a likelihood of the identified maintenance action (e.g., the confidence of the candidate match) with a threshold value. The threshold value may be determined according to any suitable techniques. If the likelihood is not greater than the threshold value (block 260, “NO”), the method 200 proceeds to block 265, and the maintenance service 120 infers that the predictive alert has been ignored by the aircraft operator (i.e., no maintenance action taken), and the maintenance service 120 does not associate (or match) the predictive alert with the maintenance action. If the likelihood is greater than the threshold value (block 260, “YES”), the method 200 proceeds to block 270, and the maintenance service 120 associates the predictive alert with the maintenance action.

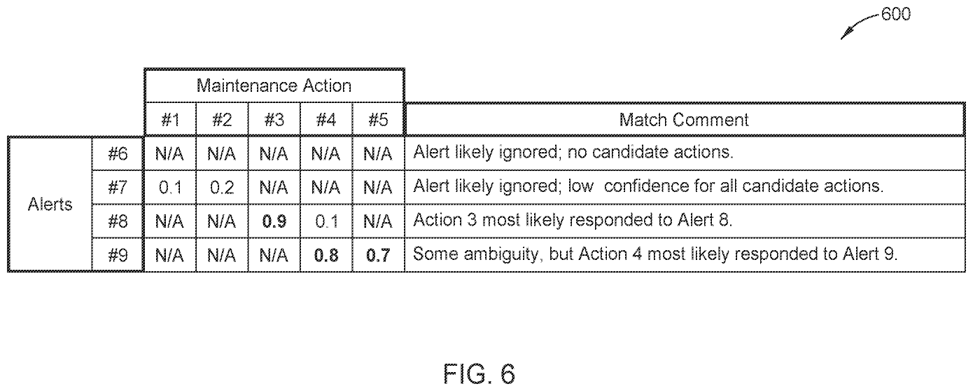

The diagram 600 of FIG. 6 depicts an exemplary technique of matching predictive alerts to maintenance actions, according to one or more aspects. The diagram 600 includes five (5) maintenance actions (#1, . . . , #5) and four (4) predictive alerts (#6, . . . , #9). The numbers of maintenance actions and predictive alerts was selected for simplicity of the example, and other numbers of maintenance actions and/or predictive alerts are also contemplated.

For the predictive alert #6, none of the maintenance actions #1, . . . , #5 has been determined as a potential match, indicating that the predictive alert #6 will likely not result in a maintenance action.

For the predictive alert #7, the maintenance action #1 has a calculated confidence of 0.1, and the maintenance action #2 has a calculated confidence of 0.2. Although the maintenance action #2 has a relatively greater confidence, neither is greater than an example threshold value of 0.5, indicating that the predictive alert #7 will likely not result in a maintenance actino. The threshold value of 0.5 was chosen for simplicity of the example, and other threshold values are also contemplated.

For the predictive alert #8, the maintenance action #3 has a calculated confidence of 0.9, and the maintenance action #4 has a calculated confidence of 0.1. Only the maintenance action #3 is greater than the example threshold value of 0.5, indicating that the maintenance action #3 most likely responded to the predictive alert #8.

For the predictive alert #9, the maintenance action #4 has a calculated confidence of 0.8, and the maintenance action #5 has a calculated confidence of 0.7. Although both of the maintenance actions #4, #5 are greater than the example threshold value of 0.5, the greater confidence value for maintenance action #4 indicates that it is more likely that the maintenance action #4 responded to the predictive alert #9 than did maintenance action #5. The method 200 ends following completion of the block 265 or the block 270.

Thus, according to various aspects described herein, the maintenance service 120 is able to automatically map each predictive alert to any correlated faults. Maintenance actions are then linked to fault occurrences, which may be predefined (e.g., not performed by the maintenance service 120) or performed according to conventional techniques. In some aspects, a predefined mapping between predictive alerts and faults may be effectively reversed to map between the faults and the predictive alerts. Using this map, a confidence of pairing each maintenance action (and its associated faults) with each predictive alert may be determined.

As will be appreciated by one skilled in the art, aspects described herein may be embodied as a system, method or computer program product. Accordingly, aspects may take the form of an entirely hardware aspect, an entirely software aspect (including firmware, resident software, micro-code, etc.) or an aspect combining software and hardware aspects that may all generally be referred to herein as a “circuit,” “module” or “system.” Furthermore, aspects described herein may take the form of a computer program product embodied in one or more computer readable storage medium(s) having computer readable program code embodied thereon.

Program code embodied on a computer readable storage medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to aspects of the present disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various aspects of the present disclosure. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order or out of order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

While the foregoing is directed to aspects of the present disclosure, other and further aspects of the disclosure may be devised without departing from the basic scope thereof, and the scope thereof is determined by the claims that follow.

What is claimed is:

1. A method comprising:
extracting structured maintenance action information from an authoritative maintenance source, the authoritative maintenance source defining a plurality of faults for a system and a respective set of one or more maintenance actions for each of the plurality of faults;
generating, for at least one fault of the plurality of faults, a respective first map of the fault to one or more relevant portions of the structured maintenance action information;
generating, for a received predictive alert, a second map of one or more related faults identified from the plurality of faults; and
identifying, based on the first maps, the second map, and maintenance records analyzed according to the structured maintenance action information, a maintenance action that is most likely indicated by the predictive alert.

2. The method of claim 1, wherein the system comprises an aircraft, and wherein the authoritative maintenance source comprises a fault isolation manual (FIM).

3. The method of claim 1, wherein generating the respective first map of the fault to the one or more relevant portions comprises:
performing natural language processing on the structured maintenance action information to identify a set of keywords and a relative frequency of each keyword in the set.

4. The method of claim 3, wherein generating the respective first map of the fault to the one or more relevant portions further comprises:
identifying, from the set of keywords, a subset of one or more keywords having a highest relative frequency.

5. The method of claim 1, wherein identifying one or more related faults for the predictive alert comprises one of the following:
determining that the predictive alert directly predicts a fault;
determining that the predictive alert predicts a common cause of the fault; and
determining that the predictive alert predicts a common effect of the fault.

6. The method of claim 1, wherein analyzing the maintenance records comprises identifying one or more of the following within individual maintenance records:
one or more references to the authoritative maintenance source;
one or more part numbers;
one or more serial numbers; and
one or more installation indicators or removal indicators.

7. The method of claim 1, further comprising:
comparing a likelihood of the identified maintenance action with a threshold value; and
inferring, when the likelihood does not exceed the threshold value, that the predictive alert did not result in a maintenance action.

8. A computer program product comprising:
a computer-readable storage medium having computer-readable program code embodied therewith, the computer-readable program code executable by one or more computer processors to perform an operation comprising:
extracting structured maintenance action information from an authoritative maintenance source, the authoritative maintenance source defining a plurality of faults for a system and a respective set of one or more maintenance actions for each of the plurality of faults;
generating, for at least one fault of the plurality of faults, a respective first map of the fault to one or more relevant portions of the structured maintenance action information;
generating, for a received predictive alert, a second map of one or more related faults identified from the plurality of faults; and
identifying, based on the first maps, the second map, and maintenance records analyzed according to the structured maintenance action information, a maintenance action that is most likely indicated by the predictive alert.

9. The computer program product of claim 8, wherein the system comprises an aircraft, and wherein the authoritative maintenance source comprises a fault isolation manual (FIM).

10. The computer program product of claim 8, wherein generating the respective first map of the fault to the one or more relevant portions comprises:
performing natural language processing on the structured maintenance action information to identify a set of keywords and a relative frequency of each keyword in the set.

11. The computer program product of claim 10, wherein generating the respective first map of the fault to the one or more relevant portions further comprises:
identifying, from the set of keywords, a subset of one or more keywords having a highest relative frequency.

12. The computer program product of claim 8, wherein identifying one or more related faults for the predictive alert comprises one of the following:
determining that the predictive alert directly predicts a fault;
determining that the predictive alert predicts a common cause of the fault; and
determining that the predictive alert predicts a common effect of the fault.

13. The computer program product of claim 8, wherein analyzing the maintenance records comprises identifying one or more of the following within individual maintenance records:
one or more references to the authoritative maintenance source;
one or more part numbers;
one or more serial numbers; and
one or more installation indicators or removal indicators.

14. The computer program product of claim 8, the operation further comprising:
comparing a likelihood of the identified maintenance action with a threshold value; and
inferring, when the likelihood does not exceed the threshold value, that the predictive alert did not result in a maintenance action.

15. A system of identifying maintenance actions for received predictive alerts, the system comprising:
a memory storing an authoritative maintenance source and maintenance records; and
one or more processors configured to:
extract structured maintenance action information from the authoritative maintenance source, the authoritative maintenance source defining a plurality of faults and a respective set of one or more maintenance actions for each of the plurality of faults;
generate, for at least one fault of the plurality of faults, a respective first map of the fault to one or more relevant portions of the structured maintenance action information;
generate, for a received predictive alert, a second map of one or more related faults identified from the plurality of faults; and
identify, based on the first maps, the second map, and maintenance records analyzed according to the structured maintenance action information, a maintenance action that is most likely indicated by the predictive alert.

16. The system of claim 15, wherein the authoritative maintenance source comprises a fault isolation manual (FIM) for an aircraft.

17. The system of claim 15, wherein generating the respective first map of the fault to the one or more relevant portions comprises:
performing natural language processing on the structured maintenance action information to identify a set of keywords and a relative frequency of each keyword in the set.

18. The system of claim 15, wherein identifying one or more related faults for the predictive alert comprises one of the following:
determining that the predictive alert directly predicts a fault;
determining that the predictive alert predicts a common cause of the fault; and
determining that the predictive alert predicts a common effect of the fault.

19. The system of claim 15, wherein analyzing the maintenance records comprises identifying one or more of the following within individual maintenance records:
one or more references to the authoritative maintenance source;
one or more part numbers;
one or more serial numbers; and
one or more installation indicators or removal indicators.

20. The system of claim 15, the one or more processors further configured to:
compare a likelihood of the identified maintenance action with a threshold value; and
infer, when the likelihood does not exceed the threshold value, that the predictive alert did not result in a maintenance action.
